(19) United States
(12) Patent Application Publication
(10) Pub. No.: US 2016/0147799 A1
(43) Pub. Date: May 26, 2016

(54) RESOLUTION OF DATA INCONSISTENCIES

(71) Applicant: Hewlett-Packard Development Company, L.P., Houston, TX (US)

(72) Inventors: Ira Cohen, Yehud (IL); Mor Gelberg, Yehud (IL); Efrat Egozi Levi, Yehud (IL)

(21) Appl. No.: 14/554,418

(22) Filed: Nov. 26, 2014

(51) Int. Cl. G06F 17/30; G06N 99/00

(52) U.S. Cl. CPC G06F 17/30303; G06N 99/005

(57) ABSTRACT

Examples disclosed herein enable identifying a feature that is common to a first dataset and a second dataset, wherein a first value of the feature in the first dataset is different from a second value of the feature in the second dataset; determining a first predicted value of the feature in the first dataset based on a second dataset classifier trained on the second dataset; determining a second predicted value of the feature in the second dataset based on a first dataset classifier trained on the first dataset; determining a first similarity score between the first value and the first predicted value; determining a second similarity score between the second value and the second predicted value; and generating a bipartite graph that comprises a first node indicating the first value, a second node indicating the second value, and an edge indicating the first or second similarity score.

### BACKGROUND

Data includes features of various types including numeric, categorical, etc. A categorical feature can describe an entity such as a country, product name, product family, business name, business unit, etc. For example, sales opportunity data contains many features that describe the entities including the product, product family being sold, the business unit selling it and the customer who purchased the product. Such entities may undergo changes over time due to, for example, changes in organization structure, product family categorization or renaming, and mergers and acquisitions of companies, resulting in changes in the values of those entities.

### BRIEF DESCRIPTION OF THE DRAWINGS

The following detailed description references the drawings, wherein:

FIG. 1 is a block diagram depicting an example environment in which various examples may be implemented as a data inconsistencies resolving system.

FIG. 2 is a block diagram depicting an example data inconsistencies resolving system.

FIG. 3 is a block diagram depicting an example machine-readable storage medium comprising instructions executable by a processor for resolving data inconsistencies.

FIG. 4 is a block diagram depicting an example machine-readable storage medium comprising instructions executable by a processor for resolving data inconsistencies.

FIG. 5 is a flow diagram depicting an example method for resolving data inconsistencies.

FIG. 6 is a flow diagram depicting an example method for resolving data inconsistencies.

FIG. 7 is a table depicting an example first dataset.

FIG. 8 is a table depicting an example second dataset.

FIG. 9 is a table depicting an example similarity matrix that shows mappings from the first dataset to the second dataset.

FIG. 10 is a table depicting an example similarity matrix that show mappings from the second dataset to the first dataset.

FIG. 11 is a diagram depicting an example bipartite graph.

### DETAILED DESCRIPTION

The following detailed description refers to the accompanying drawings. Wherever possible, the same reference numbers are used in the drawings and the following description to refer to the same or similar parts. It is to be expressly understood, however, that the drawings are for the purpose of illustration and description only. While several examples are described in this document, modifications, adaptations, and other implementations are possible. Accordingly, the following detailed description does not limit the disclosed examples. Instead, the proper scope of the disclosed examples may be defined by the appended claims.

Data includes features of various types including numeric, categorical, etc. A categorical feature can describe an entity such as a country, product name, product family, business name, business unit, etc. For example, sales opportunity data contains many features that describe the entities including the product, product family being sold, the business unit selling it and the customer who purchased the product. Such entities may undergo changes over time due to, for example, changes in organization structure, product family categorization or renaming, and mergers and acquisitions of companies, resulting in changes in the values of those entities. These changes in entities, both names and context, pose a challenge to data analytics, as old entity values do not match new entity values in certain features. For example, when a company is acquired by another, the company's name will change.

Such changes in entities values over time may generate inconsistencies in the data. Data inconsistencies can pose many technical challenges. Suppose that a company has been collecting sales data for the past several years and wants to use the data to predict the outcome of a new sales opportunity. The business unit that created the product being sold may be a strong predictor of the outcome. However, it is possible that the company underwent a re-organization and/or renaming over the years such that the specific product is associated with various different names of business units in the past sales data. The mismatch in names of the business unit makes is difficult for a machine learning method to determine it as a strong predictor.

Examples disclosed herein provide technical solutions to these technical problems by identifying a feature that is common to a first dataset and a second dataset, wherein a first value of the feature in the first dataset is different from a second value of the feature in the second dataset; determining a first predicted value of the feature in the first dataset based on a second dataset classifier trained on the second dataset; determining a second predicted value of the feature in the second dataset based on a first dataset classifier trained on the first dataset; determining a first similarity score between the first value and the first predicted value; determining a second similarity score between the second value and the second predicted value; and generating a bipartite graph that comprises a first node indicating the first value, a second node indicating the second value, and an edge indicating the first or second similarity score.

The terminology used herein is for the purpose of describing particular embodiments only and is not intended to be limiting. As used herein, the singular forms “a,” “an,” and “the” are intended to include the plural forms as well, unless the context clearly indicates otherwise. The term “plurality,” as used herein, is defined as two or more than two. The term “another,” as used herein, is defined as at least a second or more. The term “coupled,” as used herein, is defined as connected, whether directly without any intervening elements or indirectly with at least one intervening elements, unless otherwise indicated. Two elements can be coupled mechanically, electrically, or communicatively linked through a communication channel, pathway, network, or system. The term “and/or” as used herein refers to and encompasses any and all possible combinations of one or more of the associated listed items. It will also be understood that, although the terms first, second, third, etc. may be used herein to describe various elements, these elements should not be limited by these terms, as these terms are only used to distinguish one element from another unless stated otherwise or the context indicates otherwise.

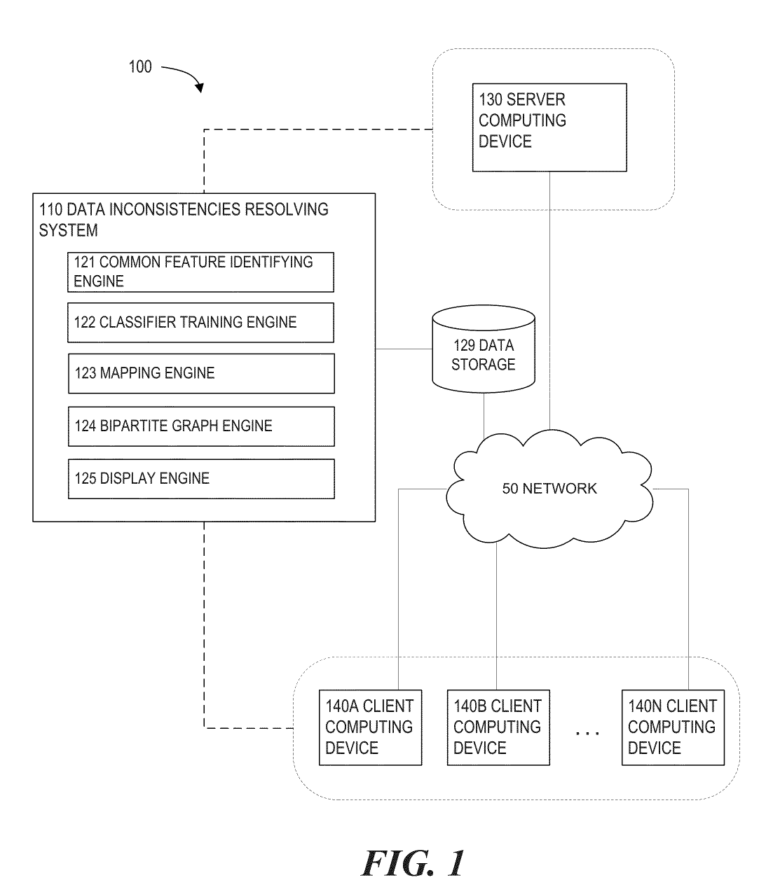

FIG. 1 is an example environment 100 in which various examples may be implemented as a data inconsistencies resolving system 110. Environment 100 may include various components including server computing device 130 and client computing devices 140 (illustrated as 140A, 140B, . . . , 140N). Each client computing device 140A, 140B, . . . , 140N may communicate requests to and/or receive responses from server computing device 130. Server computing device 130 may receive and/or respond to requests from client computing devices 140. Client computing devices 140 may be any type of computing device providing a user interface through which a user can interact with a software application. For example, client computing devices 140 may include a laptop computing device, a desktop computing device, an all-in-one computing device, a tablet computing device, a mobile phone, an electronic book reader, a network-enabled appliance such as a “Smart” television, and/or other electronic device suitable for displaying a user interface and processing user interactions with the displayed interface. While server computing device 130 is depicted as a single computing device, server computing device 130 may include any number of integrated or distributed computing devices serving at least one software application for consumption by client computing devices 140.

The various components (e.g., components 129, 130, and/or 140) depicted in FIG. 1 may be coupled to at least one other component via a network 50. Network 50 may comprise any infrastructure or combination of infrastructures that enable electronic communication between the components. For example, network 50 may include at least one of the Internet, an intranet, a PAN (Personal Area Network), a LAN (Local Area Network), a WAN (Wide Area Network), a SAN (Storage Area Network), a MAN (Metropolitan Area Network), a wireless network, a cellular communications network, a Public Switched Telephone Network, and/or other network. According to various implementations, data inconsistencies resolving system 110 and the various components described herein may be implemented in hardware and/or a combination of hardware and programming that configures hardware. Furthermore, in FIG. 1 and other Figures described herein, different numbers of components or entities than depicted may be used.

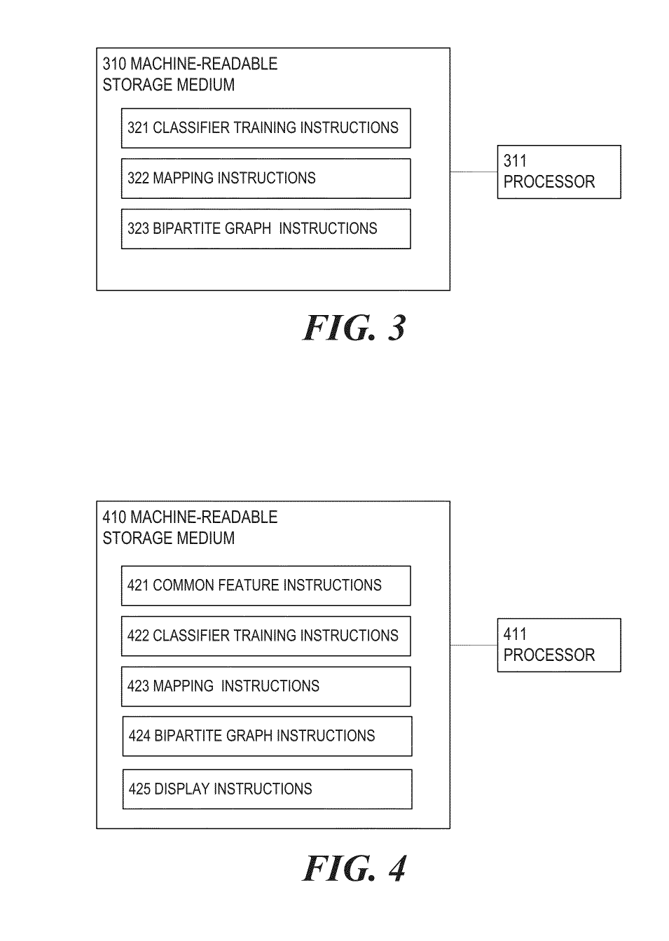

Data inconsistencies resolving system 110 may comprise a common feature identifying engine 121, a classifier training engine 122, a mapping engine 123, a bipartite graph engine 124, a display engine 125, and/or other engines. The term “engine”, as used herein, refers to a combination of hardware and programming that performs a designated function. As is illustrated respect to FIGS. 3-4, the hardware of each engine, for example, may include one or both of a processor and a machine-readable storage medium, while the programming is instructions or code stored on the machine-readable storage medium and executable by the processor to perform the designated function.

Common feature identifying engine 121 may identify a feature (referred herein as the “feature k”) that is common to a first dataset and a second dataset, wherein at least one value of the feature in the first dataset is different from at least one value of the feature in the second dataset. The first dataset and the second dataset may include the same set of features or at least one common feature. For example, in the case of sales opportunity data discussed above, both datasets would have the same set of features such as product, country, price, business unit, etc.

While the first and second datasets have the same set of features or at least one common feature, the values of a particular feature in the first dataset may be different from the values of the same feature in the second dataset. Common feature identifying engine 121 may identify the unique values of the particular feature in the first dataset and the unique values of the same feature in the second dataset. When the unique values of the feature in the first and second datasets are not identical, a mismatch in the values in that feature may be detected. This mismatch may indicate that there has been a change in the values of that feature.

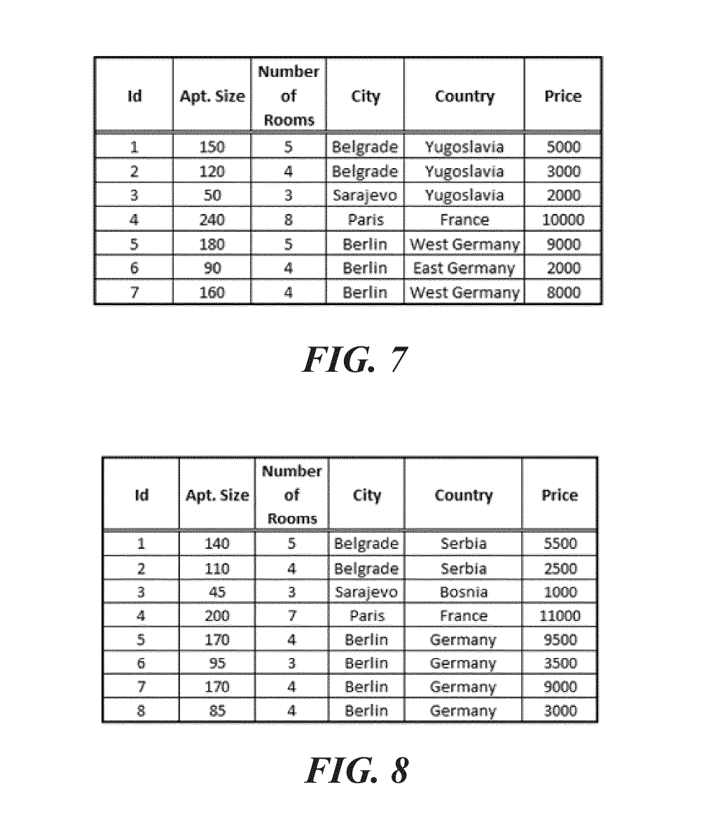

Suppose that an example dataset as illustrated in FIG. 7 represents the first dataset and another example dataset as illustrated in FIG. 8 represents the second dataset. The first dataset in FIG. 7 and the second dataset in FIG. 8 describe the prices of real estate in Europe. For purposes of illustration, the first dataset in FIG. 7 may be the old dataset and the second dataset in FIG. 8 may be the new dataset, collected before and after the reunion of East and West Germany and the split of Yugoslavia. Common feature identifying engine 121 may identify the feature “Country” as the common feature where at least one value of the feature “Country” in the first dataset is different from at least one value of the feature “Country” in the second dataset. For example, the unique values of the feature “Country” that include Yugoslavia, France, West Germany, and East Germany are not identical to the unique values of the feature “Country” that include Serbia, Bosnia, France, and Germany since at least some of the values do not match.

Classifier training engine 122 may train a first dataset classifier on the first dataset. As used herein, a “classifier” may refer to any machine learning classifier (e.g., Nearest Neighbor classifier) that may be trained using a training dataset to classify a plurality of data elements into a plurality of classes. The classifier may predict the classification of each element and/or make an assessment of the confidence in that prediction (e.g., determine a confidence score).

The training set that is used to train the first dataset classifier may be a portion of the first dataset. The portion of the first dataset may exclude the feature (e.g., the feature k) comprising a first set of values. In the example illustrated in FIG. 7, the training set used to train the first dataset classifier may include the rest of the first dataset (e.g., the remaining four features including the “Apt. Size” feature, “Number of Rooms” feature, “City,” and the feature “Price”) other than the feature “Country.”

Similarly, classifier training engine 122 may train a second dataset classifier on the second dataset. The training set that is used to train the second dataset classifier may be a portion of the second dataset. The portion of the second data set may exclude the feature (e.g., the feature k) comprising a second set of values. In the example illustrated in FIG. 8, the training set used to train the second dataset classifier may include the rest of the second dataset (e.g., the remaining four features including the “Apt. Size” feature, “Number of Rooms” feature, “City,” and the feature “Price”) other than the feature “Country.”

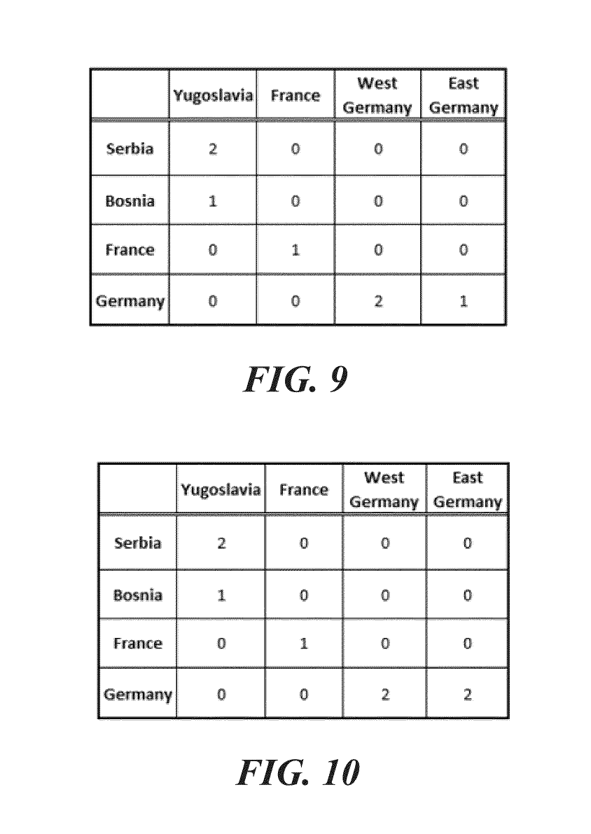

Mapping engine 123 may determine, using the second dataset classifier, first mappings from the first set of values to the second set of values. An example of the first mappings is illustrated in FIG. 9. The mapping between two feature values may be determined based on computing a similarity score for the pair of those two feature values. In the example illustrated in FIG. 9, the similarity score between the feature value “Yugoslavia” of the first dataset and the feature value “Serbia” of the second dataset may be equal to 2.

In computing such similarity scores, mapping engine 123 may determine, for each data record of the first dataset (or a portion of the first dataset), a predicted value of the feature (e.g., the feature k) using the second dataset classifier. Returning to the example above, for each data record (e.g., starting from the data record identified by Id 1) of the first dataset in FIG. 7, the second dataset classifier (trained on the second dataset) may be used to predict the value of the feature “Country.” In this example, the predicted value of the feature may be one of the unique values (e.g., Serbia, Bosnia, France, and Germany) of the feature “Country” in the second dataset (e.g., the dataset in FIG. 8).

Mapping engine 123 may determine a first similarity score between a first value of the feature in the first dataset and a first predicted value where the first predicted value may have been predicted using the second dataset classifier for the data record that contains the first value. The determination of the first similarity score may, for example, be computed based on a number of the first value (or the number of the data records having the first value) in the first dataset that was classified with the first predicted value using the second dataset classifier. In FIG. 9, the second dataset classifier has classified 2 of the data records with the feature value “Yugoslavia” in the first dataset with the predicted feature value “Serbia,” resulting in the similarity score of 2.

Similarly, mapping engine 123 may determine, using the first dataset classifier, second mappings from the second set of values to the first set of values. An example of the second mappings is illustrated in FIG. 10. The mapping between two feature values may be determined based on computing a similarity score for the pair of those two feature values. In the example illustrated in FIG. 10, the similarity score between the feature value “West Germany” of the first dataset and the feature value “Germany” of the second dataset may be equal to 2.

In computing such similarity scores, mapping engine 123 may determine, for each data record of the second dataset (or a portion of the second dataset), a predicted value of the feature (e.g., the feature k) using the first dataset classifier. Returning to the example above, for each data record (e.g., starting from the data record identified by Id 1) of the second dataset in FIG. 8, the first dataset classifier (trained on the first dataset) may be used to predict the value of the feature “Country.” In this example, the predicted value of the feature may be one of the unique values (e.g., Yugoslavia, France, West Germany, and East Germany) of the feature “Country” in the first dataset (e.g., the dataset in FIG. 7).

Mapping engine 123 may determine a second similarity score between a second value of the feature in the second dataset and a second predicted value where the second predicted value may have been predicted using the first dataset classifier for the data record that contains the second value. The determination of the second similarity score may, for example, be computed based on a number of the second value (or the number of the data records having the second value) in the second dataset that was classified with the second predicted value using the first dataset classifier. In FIG. 10, the first dataset classifier has classified 2 of the data records with the feature value “Germany” in the second dataset with the predicted feature value “West Germany,” resulting in the similarity score of 2.

Note that the first and second mappings (e.g., as illustrated in FIGS. 9 and 10) are not necessarily identical since the predictions depend on different training sets (e.g., the first mappings based on the second dataset and the second mappings based on the first dataset). For example, in FIG. 10, the score for the pair of feature values “Germany” and “East Germany” is different from its score in FIG. 9. Training two classifier, once using the first dataset and once using the second dataset, may guarantee a degree of robustness to noise and outliers.

In some implementations, mapping engine 123 may normalize the similarity scores (e.g., the first similarity score, the second similarity score, etc.). The normalization can ensure that the similarity score is invariant to the sample size of each value both in the first dataset and the second dataset. One way of normalizing the similarity scores is to normalize each score to the range of 0-1. Alternatively or additionally, any other normalization methods may be used. Mapping engine 123 may remove mappings based on low similarity scores and/or normalized similarity scores. For example, mapping engine 123 may compare the normalized score against a threshold. If the normalized score is equal to or less than the threshold, the score may be set to zero or to a predetermined number.

In some implementations, mapping engine 123 may generate a combined similarity score that combines the first similarity score and the second similarity score. The two scores (or two normalized scores) may be combined in various ways. For example, they may be combined by adding, multiplying, and/or taking a maximum or minimum value between the two scores. The combined score may be further normalized using any of the normalization methods as discussed herein.

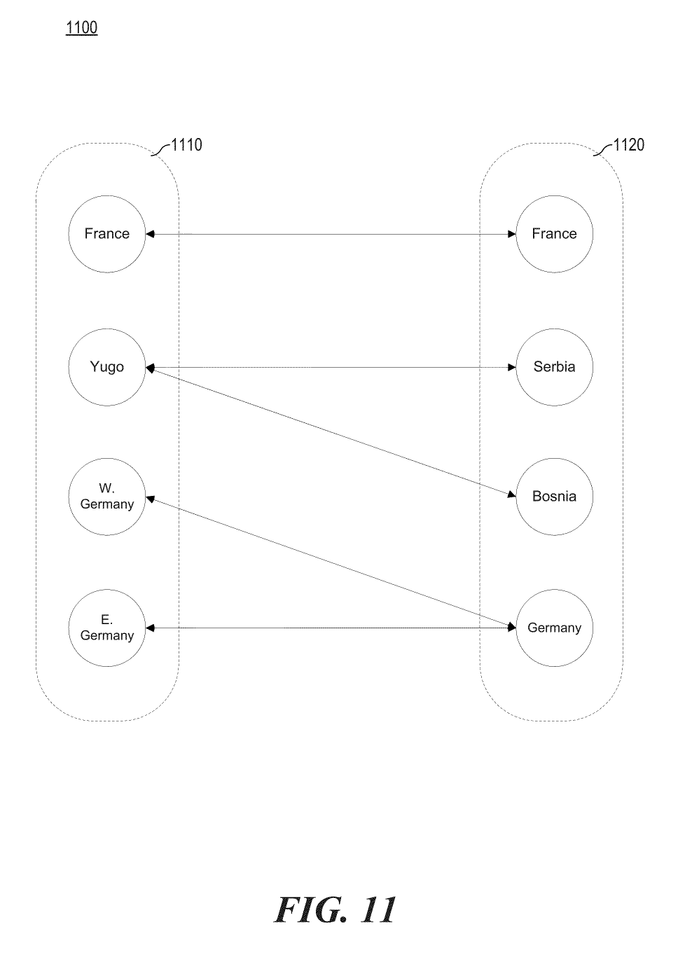

Bipartite graph engine 124 may generate a bipartite graph based on the first and/or second mappings. The bipartite graph (e.g., as illustrated in FIG. 11) may comprise a first set of nodes (e.g., the node “France,” the node “Yugoslavia,” the node “West Germany,” and the node “East Germany”) indicating the first set of values and a second set of nodes (e.g., the node “France,” the node “Serbia,” the node “Bosnia,” and the node “Germany”) indicating the second set of values. The bipartite graph may further comprise edges that connect the first set of nodes and the second set of nodes based on the first and/or second mappings. For example, an edge (e.g., a uni-directional edge from one feature value to another feature value) may exist when a similarity score (or the normalized similarity score) for a pair of feature values is greater than zero or a predetermined threshold. In some implementations, an edge may be pruned when the similarity score (or the normalized similarity score) corresponding to the edge is zero or is less or equal to the predetermined threshold.

In some implementations, the edge may be bi-directional when both the first and second mappings exist between a pair of feature values. In some implementations, the bi-directional edge may indicate the combined similarity score as discussed herein with respect to mapping engine 123. When the combined similarity score is greater than zero or a predetermined threshold, the bi-directional edge may be created between the pair of feature values in the bipartite graph.

In some implementations, the edge may be visually different depending on the first, second, and/or the combined similarity scores associated with the edge. The appearance of the edge may vary in thickness, darkness, color, shape, and/or other visual characteristics of the edge based on the similarity score. For example, an edge with a higher similarity score may appear differently (e.g., thicker line) from another edge with a lower similarity score.

Display engine 125 may cause a display of the bipartite graph to enable a user to interact with the bipartite graph via the display. The user may interact with the bipartite graph by, for example, adding, modifying, or deleting at least one of the nodes or edges of the bipartite graph. In some instances, the user may modify the similarity score associated with a particular edge. This allows the user to review, verify, and/or confirm the discovered mappings between the first dataset and the second dataset.

In performing their respective functions, engines 121-125 may access data storage 129 and/or other suitable database(s). Data storage 129 may represent any memory accessible to data inconsistencies resolving system 110 that can be used to store and retrieve data. Data storage 129 and/or other database may comprise random access memory (RAM), read-only memory (ROM), electrically-erasable programmable read-only memory (EEPROM), cache memory, floppy disks, hard disks, optical disks, tapes, solid state drives, flash drives, portable compact disks, and/or other storage media for storing computer-executable instructions and/or data. Data inconsistencies resolving system 110 may access data storage 129 locally or remotely via network 50 or other networks.

Data storage 129 may include a database to organize and store data. The database may reside in a single or multiple physical device(s) and in a single or multiple physical location(s). The database may store a plurality of types of data and/or files and associated data or file description, administrative information, or any other data.

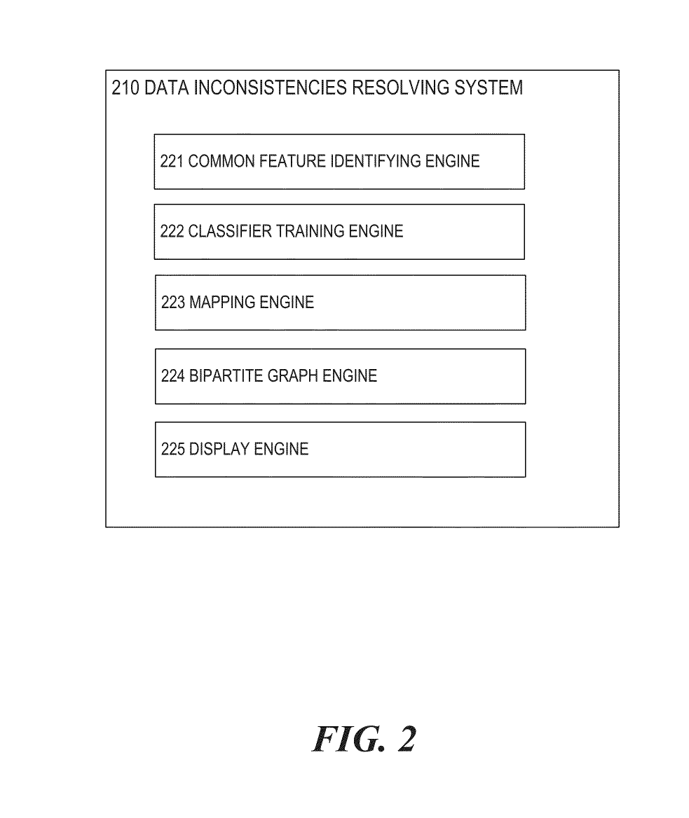

FIG. 2 is a block diagram depicting an example data inconsistencies resolving system 210. Data inconsistencies resolving system 210 may comprise a common feature identifying engine 221, a classifier training engine 222, a mapping engine 223, a bipartite graph engine 224, a display engine 225, and/or other engines. Engines 221-225 represent engines 121-125, respectively.

FIG. 3 is a block diagram depicting an example machine-readable storage medium 310 comprising instructions executable by a processor for resolving data inconsistencies.

In the foregoing discussion, engines 121-125 were described as combinations of hardware and programming. Engines 121-125 may be implemented in a number of fashions. Referring to FIG. 3, the programming may be processor executable instructions 321-323 stored on a machine-readable storage medium 310 and the hardware may include a processor 311 for executing those instructions. Thus, machine-readable storage medium 310 can be said to store program instructions or code that when executed by processor 311 implements data inconsistencies resolving system 110 of FIG. 1.

In FIG. 3, the executable program instructions in machine-readable storage medium 310 are depicted as classifier training instructions 321, mapping instructions 322, and bipartite graph instructions 323. Instructions 321-323 represent program instructions that, when executed, cause processor 311 to implement engines 122-124, respectively.

FIG. 4 is a block diagram depicting an example machine-readable storage medium 410 comprising instructions executable by a processor for resolving data inconsistencies.

In the foregoing discussion, engines 121-125 were described as combinations of hardware and programming. Engines 121-125 may be implemented in a number of fashions. Referring to FIG. 4, the programming may be processor executable instructions 421-425 stored on a machine-readable storage medium 410 and the hardware may include a processor 411 for executing those instructions. Thus, machine-readable storage medium 410 can be said to store program instructions or code that when executed by processor 411 implements data inconsistencies resolving system 110 of FIG. 1.

In FIG. 4, the executable program instructions in machine-readable storage medium 410 are depicted as common feature instructions 421, classifier training instructions 422, mapping instructions 423, bipartite graph instructions 424, and display instructions 425. Instructions 421-425 represent program instructions that, when executed, cause processor 411 to implement engines 121-125, respectively.

Machine-readable storage medium 310 (or machine-readable storage medium 410) may be any electronic, magnetic, optical, or other physical storage device that contains or stores executable instructions. In some implementations, machine-readable storage medium 310 (or machine-readable storage medium 410) may be a non-transitory storage medium, where the term “non-transitory” does not encompass transitory propagating signals. Machine-readable storage medium 310 (or machine-readable storage medium 410) may be implemented in a single device or distributed across devices. Likewise, processor 311 (or processor 411) may represent any number of processors capable of executing instructions stored by machine-readable storage medium 310 (or machine-readable storage medium 410). Processor 311 (or processor 411) may be integrated in a single device or distributed across devices. Further, machine-readable storage medium 310 (or machine-readable storage medium 410) may be fully or partially integrated in the same device as processor 311 (or processor 411), or it may be separate but accessible to that device and processor 311 (or processor 411).

In one example, the program instructions may be part of an installation package that when installed can be executed by processor 311 (or processor 411) to implement data inconsistencies resolving system 110. In this case, machine-readable storage medium 310 (or machine-readable storage medium 410) may be a portable medium such as a floppy disk, CD, DVD, or flash drive or a memory maintained by a server from which the installation package can be downloaded and installed. In another example, the program instructions may be part of an application or applications already installed. Here, machine-readable storage medium 310 (or machine-readable storage medium 410) may include a hard disk, optical disk, tapes, solid state drives, RAM, ROM, EEPROM, or the like.

Processor 311 may be at least one central processing unit (CPU), microprocessor, and/or other hardware device suitable for retrieval and execution of instructions stored in machine-readable storage medium 310. Processor 311 may fetch, decode, and execute program instructions 321-323, and/or other instructions. As an alternative or in addition to retrieving and executing instructions, processor 311 may include at least one electronic circuit comprising a number of electronic components for performing the functionality of at least one of instructions 321-323, and/or other instructions.

Processor 411 may be at least one central processing unit (CPU), microprocessor, and/or other hardware device suitable for retrieval and execution of instructions stored in machine-readable storage medium 410. Processor 411 may fetch, decode, and execute program instructions 421-425, and/or other instructions. As an alternative or in addition to retrieving and executing instructions, processor 411 may include at least one electronic circuit comprising a number of electronic components for performing the functionality of at least one of instructions 421-425, and/or other instructions.

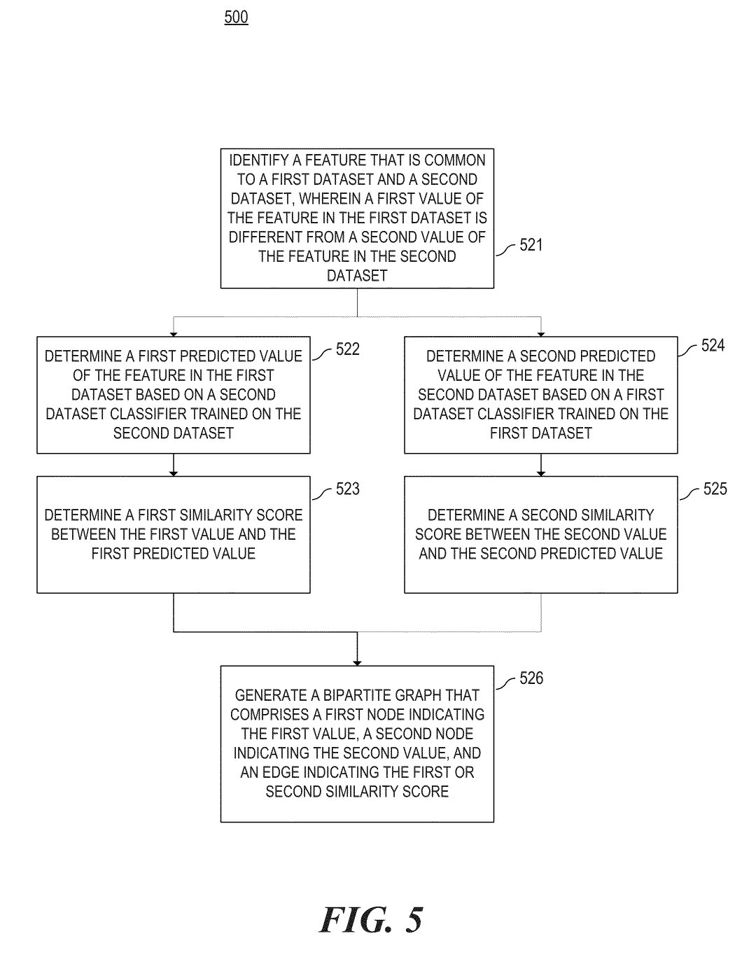

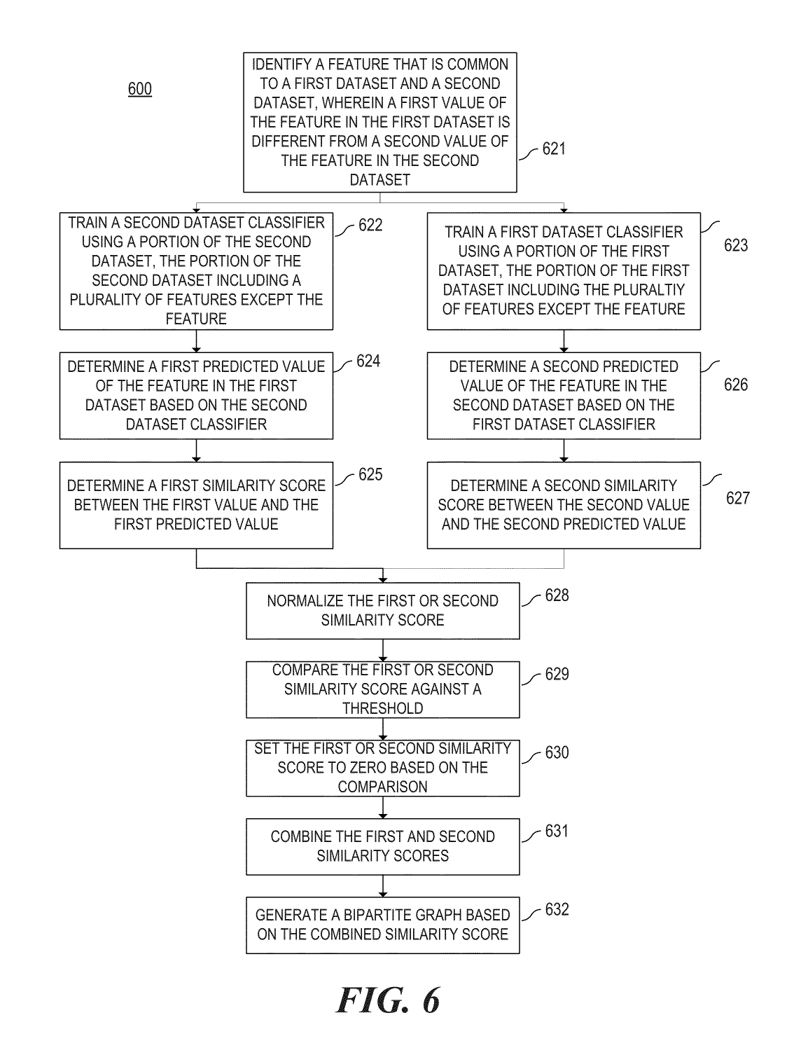

FIG. 5 is a flow diagram depicting an example method 500 for resolving data inconsistencies. The various processing blocks and/or data flows depicted in FIG. 5 (and in the other drawing figures such as FIG. 6) are described in greater detail herein. The described processing blocks may be accomplished using some or all of the system components described in detail above and, in some implementations, various processing blocks may be performed in different sequences and various processing blocks may be omitted. Additional processing blocks may be performed along with some or all of the processing blocks shown in the depicted flow diagrams. Some processing blocks may be performed simultaneously. Accordingly, method 500 as illustrated (and described in greater detail below) is meant be an example and, as such, should not be viewed as limiting. Method 500 may be implemented in the form of executable instructions stored on a machine-readable storage medium, such as storage medium 310, and/or in the form of electronic circuitry.

Method 500 may start in block 521 where method 500 may identify a feature that is common to a first dataset and a second dataset, wherein a first value of the feature in the first dataset is different from a second value of the feature in the second dataset. While the first and second datasets have the same set of features or at least one common feature, the values of a particular feature in the first dataset may be different from the values of the same feature in the second dataset. When the unique values of the feature in the first and second datasets are not identical, a mismatch in the values in that feature may be detected. This mismatch may indicate that there has been a change in the values of that feature.

In block 522, method 500 may determine a first predicted value of the feature in the first dataset based on a second dataset classifier trained on the second dataset. For example, for each data record (e.g., starting from the data record identified by Id 1) of the first dataset in FIG. 7, the second dataset classifier (trained on the second dataset) may be used to predict the value of the feature “Country.” In this example, the predicted value of the feature may be one of the unique values (e.g., Serbia, Bosnia, France, and Germany) of the feature “Country” in the second dataset (e.g., the dataset in FIG. 8).

In block 523, method 500 may determine a first similarity score between the first value and the first predicted value where the first predicted value may have been predicted using the second dataset classifier for the data record that contains the first value. The determination of the first similarity score may, for example, be computed based on a number of the first value (or the number of the data records having the first value) in the first dataset that was classified with the first predicted value using the second dataset classifier. In FIG. 9, the second dataset classifier has classified 2 of the data records with the feature value “Yugoslavia” in the first dataset with the predicted feature value “Serbia,” resulting in the similarity score of 2.

In block 524, method 500 may determine a second predicted value of the feature in the second dataset based on a first dataset classifier trained on the first dataset. For example, for each data record (e.g., starting from the data record identified by Id 1) of the second dataset in FIG. 8, the first dataset classifier (trained on the first dataset) may be used to predict the value of the feature “Country.” In this example, the predicted value of the feature may be one of the unique values (e.g., Yugoslavia, France, West Germany, and East Germany) of the feature “Country” in the first dataset (e.g., the dataset in FIG. 7).

In block 525, method 500 may determine a second similarity score between the second value and the second predicted value where the second predicted value may have been predicted using the first dataset classifier for the data record that contains the second value. The determination of the second similarity score may, for example, be computed based on a number of the second value (or the number of the data records having the second value) in the second dataset that was classified with the second predicted value using the first dataset classifier. In FIG. 10, the first dataset classifier has classified 2 of the data records with the feature value “Germany” in the second dataset with the predicted feature value “West Germany,” resulting in the similarity score of 2.

Note that the first and second similarity scores are not necessarily identical since the predictions depend on different training sets (e.g., the first similarity score based on the second dataset and the second similarity score based on the first dataset). For example, in FIG. 10, the score for the pair of feature values “Germany” and “East Germany” is different from its score in FIG. 9.

In block 526, method 500 may generate a bipartite graph that comprises a first node indicating the first value, a second node indicating the second value, and an edge indicating the first or second similarity score. The bipartite graph (e.g., as illustrated in FIG. 11) may comprise the first node (e.g., the node “France,” the node “Yugoslavia,” the node “West Germany,” or the node “East Germany”) and the second node (e.g., the node “France,” the node “Serbia,” the node “Bosnia,” or the node “Germany”). The bipartite graph may further comprise the edge that connects the first value and the second value. For example, an edge may exist when a similarity score (or the normalized similarity score) for a pair of feature values is greater than zero or a predetermined threshold. In some implementations, an edge may be pruned when the similarity score (or the normalized similarity score) corresponding to the edge is zero or is less or equal to the predetermined threshold.

Referring back to FIG. 1, common feature identifying engine 121 may be responsible for implementing block 521. Mapping engine 123 may be responsible for implementing blocks 522-525. Bipartite graph engine 124 may be responsible for implementing block 526.

FIG. 6 is a flow diagram depicting an example method 600 for resolving data inconsistencies. Method 600 as illustrated (and described in greater detail below) is meant be an example and, as such, should not be viewed as limiting. Method 600 may be implemented in the form of executable instructions stored on a machine-readable storage medium, such as storage medium 210, and/or in the form of electronic circuitry.

Method 600 may start in block 621 where method 600 may identify a feature (e.g., feature k) that is common to a first dataset and a second dataset, wherein a first value of the feature in the first dataset is different from a second value of the feature in the second dataset. While the first and second datasets have the same set of features or at least one common feature, the values of a particular feature in the first dataset may be different from the values of the same feature in the second dataset. When the unique values of the feature in the first and second datasets are not identical, a mismatch in the values in that feature may be detected. This mismatch may indicate that there has been a change in the values of that feature.

In block 622, method 600 may train a second dataset classifier using a portion of the second dataset. The portion of the second dataset may include a plurality of features except the feature (e.g., feature k). In the example illustrated in FIG. 8, the training set used to train the second dataset classifier may include the rest of the second dataset (e.g., the remaining four features including the “Apt. Size” feature, “Number of Rooms” feature, “City,” and the feature “Price”) other than the feature “Country.”

In block 623, method 600 may train a first dataset classifier using a portion of the first dataset. The portion of the first dataset may include the plurality of features except the feature (e.g., feature k). In the example illustrated in FIG. 7, the training set used to train the first dataset classifier may include the rest of the first dataset (e.g., the remaining four features including the “Apt. Size” feature, “Number of Rooms” feature, “City,” and the feature “Price”) other than the feature “Country.”

In block 624, method 600 may determine a first predicted value of the feature in the first dataset based on the second dataset classifier. For example, for each data record (e.g., starting from the data record identified by Id 1) of the first dataset in FIG. 7, the second dataset classifier (trained on the second dataset) may be used to predict the value of the feature “Country.” In this example, the predicted value of the feature may be one of the unique values (e.g., Serbia, Bosnia, France, and Germany) of the feature “Country” in the second dataset (e.g., the dataset in FIG. 8).

In block 625, method 600 may determine a first similarity score between the first value and the first predicted value where the first predicted value may have been predicted using the second dataset classifier for the data record that contains the first value. The determination of the first similarity score may, for example, be computed based on a number of the first value (or the number of the data records having the first value) in the first dataset that was classified with the first predicted value using the second dataset classifier. In FIG. 9, the second dataset classifier has classified 2 of the data records with the feature value “Yugoslavia” in the first dataset with the predicted feature value “Serbia,” resulting in the similarity score of 2.

In block 626, method 600 may determine a second predicted value of the feature in the second dataset based on the first dataset classifier. For example, for each data record (e.g., starting from the data record identified by Id 1) of the second dataset in FIG. 8, the first dataset classifier (trained on the first dataset) may be used to predict the value of the feature “Country.” In this example, the predicted value of the feature may be one of the unique values (e.g., Yugoslavia, France, West Germany, and East Germany) of the feature “Country” in the first dataset (e.g., the dataset in FIG. 7).

In block 627, method 500 may determine a second similarity score between the second value and the second predicted value where the second predicted value may have been predicted using the first dataset classifier for the data record that contains the second value. The determination of the second similarity score may, for example, be computed based on a number of the second value (or the number of the data records having the second value) in the second dataset that was classified with the second predicted value using the first dataset classifier. In FIG. 10, the first dataset classifier has classified 2 of the data records with the feature value “Germany” in the second dataset with the predicted feature value “West Germany,” resulting in the similarity score of 2.

Note that the first and second similarity scores are not necessarily identical since the predictions depend on different training sets (e.g., the first similarity score based on the second dataset and the second similarity score based on the first dataset). For example, in FIG. 10, the score for the pair of feature values “Germany” and “East Germany” is different from its score in FIG. 9.

In block 628, method 600 may normalize the first or second similarity score. The normalization can ensure that the similarity score is invariant to the sample size of each value both in the first dataset and the second dataset. One way of normalizing the similarity score is to normalize each score to the range of 0-1. Alternatively or additionally, any other normalization methods may be used.

Some mappings may be removed based on low similarity scores and/or normalized similarity scores. In block 629, method 600 may compare the normalized score against a threshold. If the normalized score is equal to or less than the threshold, the score may be set to zero (block 630).

In block 631, method 600 may combine the first and second similarity scores. The two scores (or two normalized scores) may be combined in various ways. For example, they may be combined by adding, multiplying, and/or taking a maximum or minimum value between the two scores. The combined score may be further normalized using any of the normalization methods as discussed herein.

In block 632, method 600 may generate a bipartite graph based on the combined similarity score. For example, when the combined similarity score is greater than zero or a predetermined threshold, a bi-directional edge may be created between the first value and the second value in the bipartite graph.

Referring back to FIG. 1, common feature identifying engine 121 may be responsible for implementing block 621. Classifier training engine 122 may be responsible for implementing blocks 622-623. Mapping engine 123 may be responsible for implementing blocks 624-631. Bipartite graph engine 124 may be responsible for implementing block 632.

FIGS. 7-10 are discussed herein with respect to FIG. 1-6.

FIG. 11 is a diagram depicting an example bipartite graph 1100. Bipartite graph 1100 may comprise a first set of nodes (e.g., the node “France,” the node “Yugoslavia,” the node “West Germany,” and the node “East Germany”) that correspond to a first set of values of a particular feature (e.g., the feature “Country”) in a first dataset 1110 (e.g., the first dataset in FIG. 7). Further, bipartite graph 1100 may comprise a second set of nodes (e.g., the node “France,” the node “Serbia,” the node “Bosnia,” and the node “Germany”) that correspond to a second set of values of the same feature in a second dataset 1120 (e.g., the second dataset in FIG. 8). The edges that are shown in bipartite graph 1100 may be bi-directional such that the mappings exist in both directions (e.g., from a node in first dataset 1110 to a node in second dataset 1120 and from the node in second dataset 1120 to the node in first dataset 1110). Each edge may be associated with a first similarity score for a mapping from first dataset 1110 to second dataset 1120, a second similarity score for a mapping from second dataset 1120 to first dataset 1110, and/or a combined score of the first and second similarity scores. The first similarity score, the second similarity score, and/or the combined similarity score may refer to the scores that have been normalized as discussed herein with respect to mapping engine 123 of FIG. 1.

Bipartite graph 1100 may be presented to a user to enable the user to interact with bipartite graph 1100 via a display. The user may interact with bipartite graph 1100 by adding, modifying, or deleting at least one of the nodes or edges of bipartite graph 1100. In some instances, the user may modify the similarity score associated with a particular edge. This allows the user to review, verify, and/or confirm the discovered mappings between first dataset 1110 and second dataset 1120.

The foregoing disclosure describes a number of example implementations for resolution of data inconsistencies. The disclosed examples may include systems, devices, computer-readable storage media, and methods for resolution of data inconsistencies. For purposes of explanation, certain examples are described with reference to the components illustrated in FIGS. 1-4. The functionality of the illustrated components may overlap, however, and may be present in a fewer or greater number of elements and components.

Further, all or part of the functionality of illustrated elements may co-exist or be distributed among several geographically dispersed locations. Moreover, the disclosed examples may be implemented in various environments and are not limited to the illustrated examples. Further, the sequence of operations described in connection with FIGS. 5-6 are examples and are not intended to be limiting. Additional or fewer operations or combinations of operations may be used or may vary without departing from the scope of the disclosed examples. Furthermore, implementations consistent with the disclosed examples need not perform the sequence of operations in any particular order. Thus, the present disclosure merely sets forth possible examples of implementations, and many variations and modifications may be made to the described examples. All such modifications and variations are intended to be included within the scope of this disclosure and protected by the following claims.

1. A method for execution by a computing device for resolving data inconsistencies, the method comprising:
identifying a feature that is common to a first dataset and a second dataset, wherein a first value of the feature in the first dataset is different from a second value of the feature in the second dataset;
determining a first predicted value of the feature in the first dataset based on a second dataset classifier trained on the second dataset;
determining a second predicted value of the feature in the second dataset based on a first dataset classifier trained on the first dataset;
determining a first similarity score between the first value and the first predicted value;
determining a second similarity score between the second value and the second predicted value; and
generating a bipartite graph that comprises a first node indicating the first value, a second node indicating the second value, and an edge indicating the first or second similarity score.

2. The method of claim 1, further comprising:
training the first dataset classifier using a portion of the first dataset, wherein the portion of the first dataset includes a plurality of features except the feature; and
training the second dataset classifier using a portion of the second dataset, wherein the portion of the second dataset includes the plurality of features except the feature.

3. The method of claim 1, further comprising:
determining whether to prune the edge based on comparing the first or second similarity score against a threshold.

4. The method of claim 1, wherein the determination of the first similarity score between the first value and the first predicted value is based on a number of the first value in the first dataset that was classified with the first predicted value using the second dataset classifier.

5. The method of claim 1, wherein the determination of the second similarity score between the second value and the second predicted value is based on a number of the second value in the second dataset that was classified with the second predicted value using the first dataset classifier.

6. The method of claim 1, further comprising:
normalizing the first or second similarity score;
comparing the first or second similarity score against a threshold; and
setting the first or second similarity score to zero based on the comparison.

7. A non-transitory machine-readable storage medium comprising instructions executable by a processor of a computing device for resolving data inconsistencies, the machine-readable storage medium comprising:
instructions to train a first dataset classifier using a portion of a first dataset, wherein the portion of the first dataset excludes a feature comprising a first set of values;
instructions to train a second dataset classifier using a portion of a second dataset, wherein the portion of the second dataset excludes the feature comprising a second set of values;
instructions to determine, using the second dataset classifier, first mappings from the first set of values to the second set of values;
instructions to determine, using the first dataset classifier, second mappings from the second set of values to the first set of values; and
instructions to generate a bipartite graph that comprises a first set of nodes indicating the first set of values, a second set of nodes indicating the second set of values, and a bi-directional edge that connects a first value of the first set of nodes and a second value of the second set of nodes, wherein the bi-directional edge indicates that both the first and second mappings exist between the first value and the second value.

8. The non-transitory machine-readable storage medium of claim 7, wherein the feature is common to the first dataset and the second dataset, further comprising:
instructions to compare the first set of values to the second set of values to determine whether at least one value of the first set of values is different from at least one value of the second set of values.

9. The non-transitory machine-readable storage medium of claim 7, further comprising:
instructions to predict, using the second dataset classifier, a third set of values of the feature for the first dataset; and
instructions to predict, using the first dataset classifier, a fourth set of values of the feature for the second dataset.

10. The non-transitory machine-readable storage medium of claim 9, further comprising:
instructions to generate a first similarity matrix between the first set of values and the third set of values;
instructions to generate a second similarity matrix between the second set of values and the fourth set of values; and
instructions to generate a third similarity matrix that combines the first similarity matrix and the second similarity matrix, wherein the bipartite graph is generated based on the third similarity matrix.

11. The non-transitory machine-readable storage medium of claim 9, further comprising:
instructions to determine first similarity scores between the first set of values and the third set of values;
instructions to determine second similarity scores between the second set of values and the fourth set of values; and
instructions to determine whether to remove the first or second mappings based on comparing the first or second similarity score against a threshold.

12. A system for resolving data inconsistencies comprising:
a processor that:
identifies a feature that is common to a first dataset and a second dataset, wherein at least one value of the feature in the first dataset is different from at least one value of the feature in the second dataset;
trains a first dataset classifier using a portion of the first dataset, wherein the portion of the first dataset excludes the feature comprising a first set of values;
trains a second dataset classifier using a portion of the second dataset, wherein the portion of the second dataset excludes the feature comprising a second set of values;
determines, using the second dataset classifier, first mappings from the first set of values to the second set of values;
determines, using the first dataset classifier, second mappings from the second set of values to the first set of values;
generates a bipartite graph comprising edges that indicate the first and second mappings; and
causes a display of the bipartite graph to enable a user to interact with the bipartite graph via the display.

13. The system of claim 12, wherein the user interacts with the bipartite graph by adding, modifying, or deleting at least one of the edges of the bipartite graph.

14. The system of claim 12, wherein the bipartite graph comprises a first set of nodes indicating the first set of values, a second set of nodes indicating the second set of values, and the edges that connect the first set of nodes and the second set of nodes.

15. The system of claim 14, wherein the edges are bi-directional such that that both the first and second mappings exist between the first set of nodes and the second set of nodes that are connected by the edges.
